(19) United States
(12) Patent Application Publication
(10) Pub. No.: US 2008/0103990 A1
(43) Pub. Date: May 1, 2008

(54) System and Method for Managing Workflow Using a Configurable Bill of Materials and Data Element Repository

(76) Inventors: Philip G. Danielson, Madison Heights, MI (US); Frank J. McPherson, West Bloomfield, MI (US)

Correspondence Address: FISH & RICHARDSON P.C., P.O. BOX 1022, MINNEAPOLIS, MN, 55440-1022, US

(21) Appl. No.: 11/555,201

(22) Filed: Oct. 31, 2006

(51) Int. Cl. G06F 17/00

(52) U.S. Cl. 705/400

(57) ABSTRACT

Systems and methods may facilitate approval of a task, where the task is a technology infrastructure change for an enterprise. A system may receive an identity of a task from a user. Components needed for a task may be identified. Needed components for the task may be compared to an inventory of available components. Prices for needed components in the inventory and/or a total price for needed components for a task may be determined. The total price, identities of needed components, and/or task information may be transmitted to approvers.

### TECHNICAL FIELD

This invention relates to systems and methods for managing workflow, and more particularly to managing task requests for changing technology infrastructures.

### BACKGROUND

Companies implement technology infrastructure changes to update systems, solve existing problems, and/or to meet business, industry and/or government standards. Governing and applying changes in technology infrastructure for enterprises may be difficult. Some changes become quickly out-of-date. Others are periodic tasks for an enterprise, while still other changes relate to emerging standards for industries. The differences in the types of changes in a technology infrastructure can also make management and implementation of these changes difficult. In addition, management approvals of requests for technology infrastructure changes may vary among similar projects. Asset allocation and utilization may also be difficult to track across an enterprise.

### SUMMARY

Systems and processes may facilitate approval of a task, such as a technology infrastructure change for an enterprise. A task identity may be transmitted to a system and the system may assemble information related to the task, such as components needed for the task and/or prices to facilitate approving or disapproving the task. The system may transmit the assembled information to approvers and may also automatically notify one or more parties regarding the approval or disapproval of tasks.

In one general aspect, components needed for a task (e.g., a technology infrastructure change for an enterprise) may be identified, needed components for a task may be compared to an inventory of available components, prices for needed components and a total price may be determined, and/or a total price, identity of one or more of the needed components, or task information may be transmitted to approvers.

Implementations may include one or more of the following features. Components may include software and/or hardware. Identifying components may include comparing a task to an inventory of available components. Identities of needed components may be transmitted to a user for approval. A designation of an available component may be changed by the system, for example, when the component is associated with a task pending approval the designation may be changed to unavailable. It may be determined that one or more needed components are unavailable in the inventory and a request for use of one or more of the unavailable needed components may be transmitted to an approver. Use of an unavailable needed component may be automatically approved when the unavailable needed component satisfies predetermined criteria. Total price, identities of needed components, task information, and/or a decision of other approvers may be automatically transmitted to a first level of approvers and/or additional levels of approvers. A task may be automatically approved when the task satisfies predetermined criteria. A status update may be transmitted to a user, persons identified by a user, and/or approvers. Reports may be generated. Databases may be updated. For example, a database of components in an inventory may be updated to include unavailable needed components that are approved by approvers. As another example, a database of needed components for various tasks may be updated to associate unavailable needed components with a task once use of the unavailable needed components is approved by an approver. Identities of a task and/or needed components may be stored.

In another general aspect, a system may include database(s) for storing data regarding a task, such as a change in technology infrastructure for an enterprise, and a task management utility for managing data stored in the database(s). Stored data may include task information for various tasks; identities of needed components for various tasks; a listing of an inventory for an enterprise where the listing may include identities of components, availability of components, and/or prices of components; and/or supply lists for vendors that include prices of components available from the vendors.

In some implementations, the described systems and techniques may facilitate increased uniformity in approvals, task allotments, and/or implementation of similar tasks (i.e., if only VPs and accountants get accounting software, a new task of installing new accounting software would only be implemented according to that business rule). By utilizing similar components for similar tasks and identifying when modifications to needed components lists are implemented, approvers may be able to more consistently approve/reject task requests, increase asset utilization, and/or increase accuracy of cost forecasts. In addition, costs associated with a task may be more accurately predicted and/or controlled by utilizing past experience in determining what components are needed for a task and how much components should cost. The described systems and techniques may facilitate standardization of tasks (i.e., programmers on similar tasks get similar personal computers, servers, and/or databases.)

The details of one or more implementations are set forth in the accompanying drawings and the description below. Other features will be apparent from the description, the drawings, and from the claims.

### DESCRIPTION OF DRAWINGS

FIG. 1 illustrates an example of a system for managing task approvals.

FIG. 2 illustrates a flowchart of a process for managing task approval.

FIG. 3 illustrates a flowchart of another example process for managing task approval.

FIG. 4 illustrates an example of a system for approving tasks.

Like reference symbols in the various drawings indicate like elements.

### DETAILED DESCRIPTION

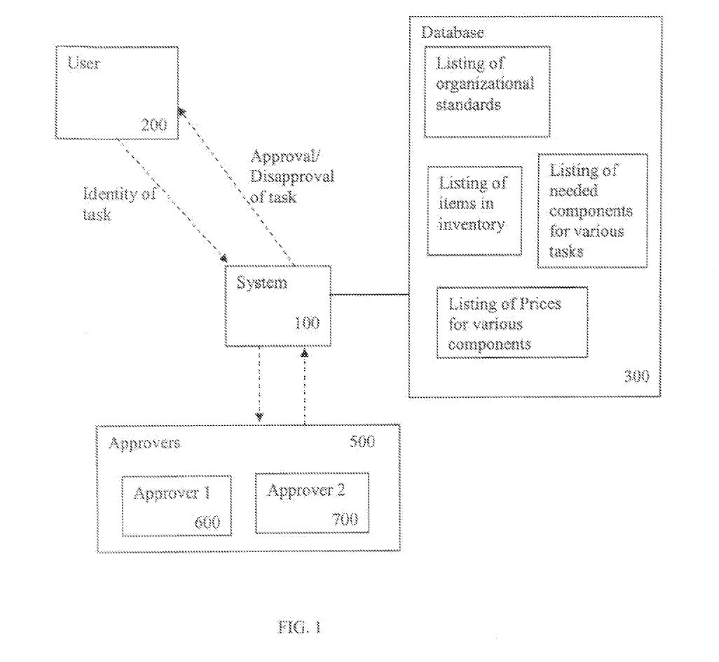

FIG. 1 illustrates an example of a workflow management system 100 for managing task approval. Tasks may include changes in technology infrastructure for an enterprise. For example, tasks may include, but are not limited to, product development, software development, software changes or updates, implementation of new software, upgrade or addition of servers or other components of a technology infrastructure, upgrade or addition of personal computers used in an enterprise, update software associated with hardware in a technology infrastructure for an enterprise, implementation of new infrastructure organizational rules, and the like.

A user 200 may access the system 100 to request approval of a task. A user may include a software programmer, a manager, a consultant, and/or other parties. The user 200 may transmit the identity of the task and/or task information to the system 100. Task information may include time to complete task, deadlines, recommended protocols, implementation details, recommended or needed components, reasons for task completion, alternatives to the task, details of related tasks, and/or other information.

The system 100 may receive the request from the user via one or more network protocols, such as via a website coupled to the system. The system 100 may include a processor and/or memory. Processors may include any programmable logic device or microprocessor. Memory may include installation medium (e.g., a CD-ROM or floppy disks), volatile memory (e.g., DRAM, SRAM, EDO RAM, Rambus RAM), or non-volatile memory such as a magnetic media (e.g., a hard drive or optical storage) or flash media. Updating software or program instructions associated with the system may be facilitated when the system is stored on a memory of the system rather than partially on a user's computer. Memory of the system may include data such as task identities, components needed for various tasks, components available and/or unavailable in an inventory of the enterprise, prices for various components, vendor supply lists, previous decisions on tasks by approvers, status of approval of tasks, status of approved tasks, and/or other information related to the management of task approval. The system may access the data from the memory to assemble information that may facilitate making a decision on a task.

In some implementations, the system 100 may be coupled to and/or include one or more databases 300. Databases 300 may include data, such as, listings of organizational standards, listings of items in inventories for an enterprise, listings of needed components for various tasks, and/or listings of prices for various components. The system may retrieve data, from the databases 300, to facilitate approval of a specific task by an approver. For example, the system may retrieve data on needed components for the task and/or prices for needed components to facilitate approval of the task by an approver. As another example, the system may retrieve data from the database of organizational standards to ensure compliance with organizational standards, such as for creating listings of needed components for a task, for components that can be used in tasks, or other types of organizational standards established by an enterprise. Organizational standards may be policies established by the enterprise and/or approvers for task management.

The system 100 may request pricing information, preferred vendor lists, pre-negotiated contract prices, estimated time lapse from order to receipt of unavailable components, and/or alternatives for unavailable components. The system may associate the information obtained with the task for which approval is requested. The system 100 may transmit information received from a user 200 and/or databases 300 to one or more approvers 500. The system 100 may receive a decision regarding a task from the approvers 500. In some implementations, approvers may include more than one level of approvers. As depicted in FIG. 1, the system may include a first set of approvers 600 and a second set of approvers 700. In certain implementations the system 100 may transmit approval, disapproval and/or status of a decision regarding a task to the user 200, approvers 500, and/or others designated by the user and/or approvers.

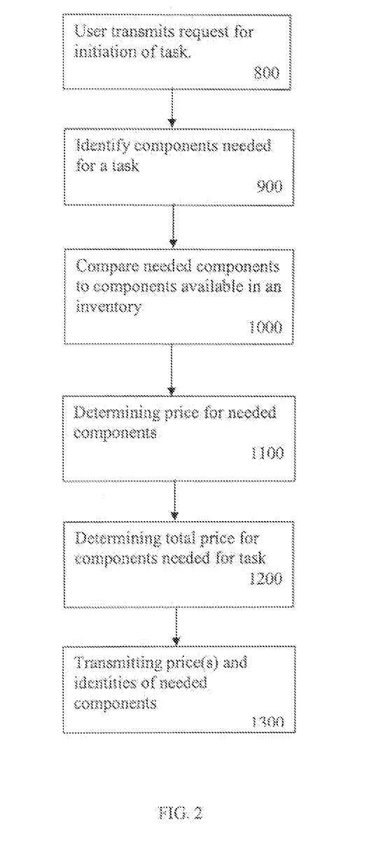

FIG. 2 illustrates a flowchart of an example process for managing task requests. A user may transmit a request for initiation of a task (operation 800). For example, the user may transmit the request via one or more network protocols, such as by accessing a website coupled to the system.

Components needed for a task may be identified (operation 900). Components may include tangible and non-tangible needs for completion of a task. For example, components may include software, hardware (e.g., power supply, motherboard, or memory), office space, raw materials, parts, subassemblies, overhead costs, storage area for components such as a warehouse, and/or offices for personnel on task. Components may be identified to account for costs of manufacturing a product and/or components that contribute to the cost of implementing and/or developing a product. In some implementations, components may be internally made. Substitutes for components may be available.

In some implementations, components for a task may be identified by comparing the task to a database of components needed for various tasks (e.g., predetermined lists of components needed for certain common tasks). A listing of needed components may be created by the system by retrieving information from similar tasks in the database of components needed for various tasks. In certain implementations, the listing of needed components may be transmitted to the user to verify. A user may provide identities of one or more of the needed components for the task and/or replace identities of one or more of the needed components from the listing created by the system.

In some implementations, data from a database of organizational standards may be accessed to determine compliance of the listing of components to the organizational standards. The task and/or task information may be analyzed for compliance with data in the database of organizational standards. For example, organizational standards may limit changes to an accounting system of an enterprise during the last month of the accounting year for tax purposes and tasks implementing changes to the accounting system may be modified.

Needed components may be compared to an inventory of available components (operation 1000). For example, a database may include a listing of components available in an inventory. The system may compare the listing of needed components to the inventory listing in the database. A listing of inventory components in a database may include a designation. Non-limiting examples of designations may include indicating whether the component is available or unavailable, whether the component would need to be made internally or purchased, number of units available, a part number, and/or whether the component is an alternative for another component. The system may determine whether alternatives are available for unavailable components (e.g., if 512 MB of video RAM needed for a task is unavailable, an alternative may be 256 MB of video RAM and an additional 256 MB of shared RAM).

Prices for needed components for the task may be determined (operation 1100). For example, prices of components available and/or unavailable in the inventory may be determined. A price for a component may be based on a price paid for a component by an enterprise, a vendor price, a vendor contract price, and/or an estimate. A total price for needed components may be determined (operation 1200). For example, the total price may be based on the sum of prices of at least a portion of the needed components for the task.

The total price, prices for needed components, and/or task information may be transmitted to one or more approvers (operation 1300). Approvers may be members of the enterprise. Approvers may be people or computers capable of making a decision regarding a task or needed components of a task. For example, approvers may include computer systems capable of automatically making decisions based on predetermined criteria, such as price, availability of components, business rules, industry rules, and/or government standards. In some implementations, the system may assign a task automatically to a specific approver.

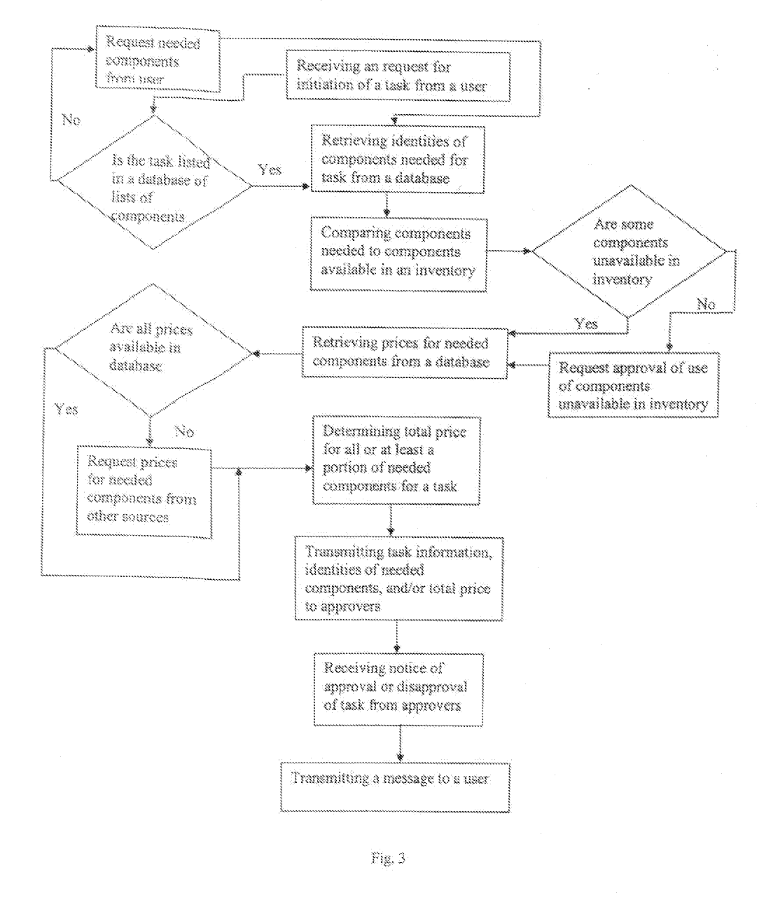

FIG. 3 depicts another process for managing approval of a task. A request for initiation of a task may be received from a user (operation 1400). For example, the user may send a message (e.g., an XML message) to the system requesting initiation and/or approval of the task. In another example, a user may request initiation and/or approval of a task via a graphical interface created by the system and coupled to the user's computer via one or more network protocols. The system may determine if the task is included in a listing of various tasks on a database (operation 1500). Listings may include, for example, predefined tasks, periodically performed tasks, and/or previously approved tasks. For example, the system may be coupled to one or more databases that include needed components for various tasks and/or tasks previously approved by the enterprise. If the task or a similar task exists in the database, then a listing of needed components may be created by the system. If a task is not included in a listing of various tasks on a database, the system may request that the user provide identities of needed components for the task (operation 1600). If the task is included in a listing of various tasks on a database, identities of components needed for the task may be retrieved from a database (operation 1700). A user may be provided with a system created listing of needed components based on similar tasks or identical tasks.

The system may transmit a listing of needed components for a task to a user for approval (not shown). A user may approve and/or modify a listing of needed components. The modified listing and/or approval of the user may be received by the system. If a user modifies a listing of needed components, the system may transmit the modified listing of needed components to an approver. For example, a user may include additional components to the listing of needed components due to the task (e.g., although the last time software was upgraded a 156 MB RAM upgrade was required, now a 256 MB RAM upgrade should be performed.) In some implementations, a system may transmit only modifications to a listing of needed components for a task to an approver. The system may transmit modifications of listings of needed components for a task to an approver with the transmittal of total price, identities of components of the task, and/or task information for approval of the task. The system may receive the approval and/or disapproval of the modifications to the listing of needed components to the task from the approver. In some implementations, a database of various tasks may be updated based on the listing of needed components for a task, for example, if modifications to a listing of needed components are approved.

The system may compare identities of needed components to an inventory of available components (operation 1800). For example, the system may retrieve identities of components available in the inventory from a database coupled to the system. The system may change a designation of needed components available in the inventory to associate the components with the task pending approval. For example, the designation of an available needed component may be changed to unavailable pending approval or unavailable until a specified date (e.g., the date of approval or date of task completion).

The system may determine if some of the needed components are unavailable in the inventory (operation 1900). For example, if needed components are not available in the inventory in the time frame required and/or alternative to the needed components are not available, then the components may be identified as unavailable. Unavailable components may need to be purchased by the enterprise for use with the task. If some of the needed components are unavailable in the inventory, the system may transmit the identity of unavailable needed components to an approver and/or require approval of unavailable needed components (operation 2000). In some implementations, the approval of use of unavailable needed components may be requested when approval of the task is requested (e.g., operation 2500). If an approver does not approve unavailable needed components, a message may be transmitted to a user. In some implementations, a request for an alternative component to the disapproved unavailable needed component for the task may be requested from the user. If an approver approves unavailable needed components, a database including a listing of items in an inventory may be updated and/or modified and prices for the needed components may be determined.

Prices for needed components may be retrieved from a database (operation 2100). For example, the system may retrieve prices from databases coupled to the system remotely or directly. The system may retrieve prices for unavailable needed components from vendor supply lists or pre-negotiated contract prices stored on a database of the system. Prices may be estimates. Prices for components available in the system (e.g., costs such as electrical of use of the component, depreciation of the component due to use, price paid for component, etc.) may be stored on a database coupled to the system.

The system may determine if prices are available for all of the needed components of the task (operation 2200). If all prices are not available, the system may request the prices from other sources, such as a vendor or remote system (operation 2300). Other sources, such as managers or accounting departments within the enterprise, vendor supply lists, historical price data, or pre-negotiated contract prices, may be coupled to the system via one or more network protocols.

A total price for needed components of a task may be determined (operation 2400). A total price may be a sum of prices of needed components for a task. A total price may be based on a sum of prices of a portion of the needed components for a task. In some implementations, a total price may be based on an estimate of prices of needed components. A total price may exclude needed components under an estimated price (e.g., when a component price is unavailable but estimated under a predetermined price).

Total price, prices of needed components, availability of components, and/or task information may be transmitted to one or more approvers (operation 2500). For example, the system may send a message such as an XML message or email transmitting the total price, prices of needed components, availability of components, and/or task information to the approver. The system may send an approver link(s) to record(s) in database(s) that include the information needed for approval of the task. Approvers may include multiple levels of approvers. Once an approver and/or final set of approvers have reached a decision regarding approval of the task, a message may be transmitted to the system.

The system may receive notice of approval or disapproval of a task from approvers (operation 2600). For example, approvers may change a designation associated with the task from pending to approve or disapproved. Approvers may transmit a message to the system indicating approval of the task.

In some implementations, a message may be transmitted to a user who requested the task (operation 2700). Messages may also be transmitted to approvers and/or others designated by the user and/or approvers. In some implementations, a message may be transmitted to predetermined people, such as, but not limited to, a user, approvers who evaluated the request for task approval, managers of technology changes, or accounting departments. A message may include a decision from approvers.

In some implementations, a task may be automatically compared to predetermined criteria, such as business rules, to determine if the task can be automatically approved or disapproved. For example, business rules may allow automatic approval of tasks in which all components are available and/or total cost is within a predetermined price range. In other implementations, predetermined tasks may be automatically approved. Automating approval of predetermined tasks may free approver resources for more complex task approvals and/or decrease the approval time for a task request.

In some implementations, one or more databases may be updated and/or modified based on approval or disapproval of tasks. For example, if a task is approved, it may be added to a database of needed components for various tasks. A designation of needed components available in the inventory may be changed (e.g., on hold for task A to available, on hold for task A to unavailable, or from available to unavailable). An approver may indicate whether the system should update and/or modify one or more databases based on the approval or disapproval of the task.

In some implementations, a task may include developing software. A system may receive a request from a program developer for the task of developing software. The system may retrieve needed components for a similar software development from a database. For example, the system may identify needed components for the task as 5 programmers, 5 personal computers, 5 cubicles, and a UNIX server. In some implementations, the system may transmit a listing of the needed components to the user for confirmation. The user may modify the listing of needed components, such as by adding an SQL database to the needed components listing. The system may receive the modified listing of needed components.

The system may determine if needed components are available in the inventory. The system may determine if needed components are available by comparing a listing of available items in the inventory database to the listing of needed components for the task. Unavailable components may be identified and the identities of the unavailable needed components may be transmitted to an approver. In some implementations, if an unavailable needed component is included in the inventory but unavailable, approval of use of the unavailable needed component may be automatic. For example, for commonly used components or predetermined components, and/or components under a predetermined price, approval for use with a task may be automatic.

Prices for each of the needed components may be determined by retrieving prices from a database. Prices for unavailable components may be determined from other sources, such as from a database of historical prices, vendor lists, requests to vendors, and the like. In some implementations, a price for predetermined items may not be determined (e.g., warehouse space owned by the enterprise), estimated (e.g., from previous prices for component), and/or disregarded (e.g., for low cost items such as 5-1 GB RAM, for use of underutilized items, such as storage space on an existing unused database). A total price for the needed components of the task may be determined. The total price may be based on a sum of prices for some or all of the needed components. Total price, prices of needed components, availability of components (available, available in 3 months, on order, on back order, expected in 10 months) and/or task information may be transmitted to an approver.

An approver may determine whether to approve, disapprove, and/or submit the request for further approval. In some implementations, the system may automatically submit the request for further approval by an additional level of approver. The system may transmit a message to the user, approvers and/or persons designated by the user and/or approver regarding the status of the approval of the task and/or a decision regarding the task.

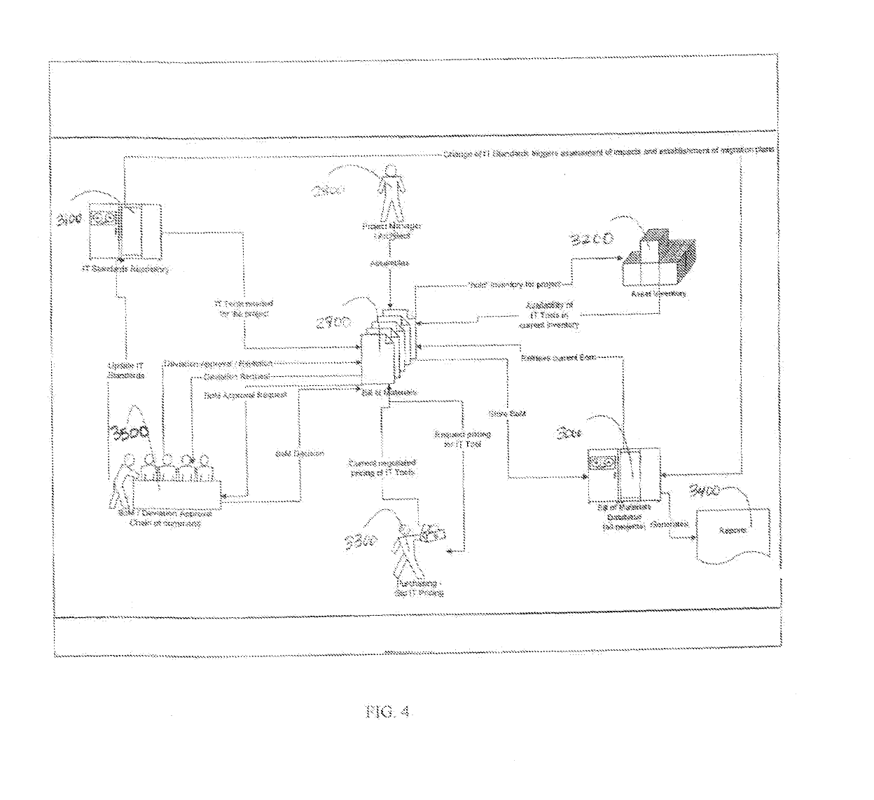

As illustrated in FIG. 4, the system may be used to facilitate compilation of a bill of materials or task information for a task. The task may include a change in information technology (IT) standards for an enterprise. A user such as a project manager or project architect 2800 may access the system, such as via the Internet. The system may receive a request for approval for the task from the project manager 2800. The system may be used by the project manager 2800 to facilitate assembly of a bill or materials or task information 2900 for the task. The bill of materials may be stored on a bill of materials database 3000 coupled to the system. The bill of materials 2900 may be manually generated (e.g., by the project manager) or the system may access a database, such as an IT standards repository 3100, that includes identities and/or descriptions of various tasks and needed components for the tasks. The user and/or the system may obtain identities of needed components, or a listing of IT Tools, for the task based on the various tasks in the IT standards repository 3100. For example, the system may determine whether the task request received from the project manager 2800 is similar to various tasks in the IT standards repository 3100 and/or assemble a listing of needed components for the task from the data in the IT standards repository. In some implementations, a user may select an at least similar task from the IT standards repository 3100 to generate a listing of needed components for the task. The generated listing of needed components for the task associated with the bill of materials 2900 and/or stored in the bill of materials database 3000. The project manager 2800 may review, modify, and/or approve the generated listing of needed components for the task by retrieving the bill of materials 2900 from the bill of materials database 3000.

The system may determine if needed components identified in the bill of materials 2900 for the task are available in an inventory 3200 of the enterprise. Needed components that are available in the inventory 3200 may be designated as associated the task (e.g., components may be designated “on hold” or “pending approval for task”). The system may determine if alternatives to the needed components that are unavailable in the inventory 3200 are available in the inventory.

The system may determine prices for needed components, or IT Tools, for the task. For example, the system may receive current negotiated pricing for each of the needed components from a purchasing department 3300. In some implementations, the system may retrieve current negotiated pricing from a database coupled to the system. The system may associate the determined prices for the needed components with the bill of materials 2900 and/or store the determined prices in the bill of materials database 3000.

The task request; task information and/or identity; availability, and/or prices of needed components may be associated with the bill of materials 2900 for the task request. These associated items may be stored in the bill of materials database 3000. At least a portion of the bill of materials 2900 and/or a link to records storing the bill of materials in the bill of materials database 3000 may be transmitted to one or more approvers 3500.

The approvers 3500 may approve or reject a task request. The approvers 3500 may approve or reject deviations from the generated listing of needed components from a task based on the IT standards repository 3100 (e.g., components changed or added by the Project Manager 2800).

The IT standards repository 3100 may be updated, if the approvers 3500 approve deviations to the listing of needed components generated based on the IT standards repository. In some implementations, the approvers 3500 may determine that a task should be added to the IT standards repository 3100, alternatives for a component should be added to the system and/or databases, and/or whether databases and/or pending tasks should be modified based on the approved task (e.g., if an approved task includes modifying an accounting system of an enterprise, a pending task of training new employees on the accounting system may be suspended and/or terminated). The system may receive a request from the approvers 3500 to modify databases and/or pending tasks. The approval of a task such as changing IT standards and/or changes to the IT standards repository 3100 may affect other tasks and the system may assess the impact and/or establish appropriate migration plans. Bill of materials 2900 for other tasks stored in the Bill of materials database 3000 may be modified based on the established migration plans.

The system may generate reports 3400. Reports 3400 may include: notifications on modifications to databases (e.g., IT standards repository 3100 or bill of materials database 3000), asset inventory 3200, and/or other tasks; implications of updates to databases and/or asset inventory; synchronization of databases (e.g., updating the approvers), warnings of changes to various procedures or standards, status for tasks, status of approval for tasks, and the like.

The system and techniques described may increase accuracy of inventory level assessments. The system and techniques described may also increase accuracy of pricing for various tasks. Increasing accuracy of pricing for various tasks may facilitate approval by approvers since approvers have a more accurate reflection of true costs for a project. Increased accuracy in pricing and/or increased accuracy of inventory levels may also result in cost savings for an enterprise since costs may be more accurately managed and tracked. The systems and techniques described may facilitate enterprise-wide tracking of costs and status of approval for tasks. The systems and techniques described may facilitate planning for fiscal years, for example, by identifying repeat tasks and/or budgetary needs for ongoing tasks. The systems and techniques described may facilitate management and implementation of information technology (IT) standards. Consistent treatment of tasks may be increase since needed components for tasks may be automatically created, modifications may be flagged or sent to approvers for approval, and/or more accurate global view of pending tasks may be available to approvers.

Although the user, the project manager, the project architect, the vendor, and the approver have been described as a human, they may be a person, a group of people, a person or persons interacting with one or more computers, and/or a computer system.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, pricing information may be obtained from the system rather than from a remote system. As another example, databases may be coupled to the system through a remote system as opposed to directly coupled to the system. Among other modifications, the described operations may be performed in a different order than is described and some operations may be added or deleted. For example, prices for needed components may not be determined. As another example, approval for use of unavailable needed components may not be sought or may only be requested with a request for approval of the task from approvers. Accordingly, other implementations are within the scope of this application.

It is to be understood the implementations are not limited to particular systems or processes described. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a database” includes a combination of two or more databases and reference to “a task” includes mixtures of different types of tasks.

What is claimed is:

1. A method comprising:
identifying components needed for a task comprising a change in a technology infrastructure for an enterprise, wherein identifying one or more of the needed components comprises comparing the task to a database of components needed for various tasks;
comparing one or more of the needed components to an inventory of available components;
determining a price for at least one of the needed components that is included in the inventory;
determining a total price for the needed components, wherein the total price comprises a sum of the prices of more than one of the needed components; and
transmitting at least one of the total price, identities of one or more of the needed components, or task information to one or more approvers.

2. The method of claim 1, further comprising transmitting the identity of one or more needed components to a user for approval.

3. The method of claim 1, wherein at least one of the components comprises at least one of software or hardware.

4. The method of claim 1, further comprising changing a designation one or more of the available needed components to unavailable.

5. The method of claim 1, further comprising:
determining whether one or more of the needed components is unavailable in the inventory; and
transmitting a request for use of one or more of the unavailable needed components to at least one of the approvers.

6. The method of claim 5, further comprising automatically approving use of one or more of unavailable needed components when one or more of the unavailable needed components satisfies a predetermined criteria.

7. The method of claim 1, wherein transmitting at least one of the total price, identities of one or more of the needed components, or task information comprises:
automatically transmitting at least one of the total price, the identities of one or more of the needed components, or task information to a first level of approvers; and
automatically transmitting at least one of the total price, identities of one or more of the needed components, task information, or a decision of the first level of approvers to one or more additional levels of approvers.

8. The method of claim 1, further comprising automatically approving the task when the task satisfies predetermined criteria.

9. The method of claim 1, further comprising transmitting a status update to the user, persons identified by the user, and/or one or more of the approvers.

10. The method of claim 1, further comprising generating a report.

11. The method of claim 1, further comprising updating a database of components in the inventory to add one or more unavailable needed components when use of one or more of the unavailable needed components is approved by at least one of the approvers.

12. The method of claim 1, further comprising storing the task and the identities of needed components.

13. An article comprising a machine-readable medium storing instructions operable to cause one or more machines to perform operations comprising:
identifying components needed for a task comprising a change in a technology infrastructure for an enterprise, wherein identifying one or more of the needed components comprises comparing the task to a database of components needed for various tasks;
comparing one or more of the needed components to an inventory of available components;
determining a price for at least one of the needed components that is included in the inventory;
determining a total price for the needed components, wherein the total price comprises a sum of the prices of more than one of the needed components; and
transmitting at least one of the total price, identities of one or more of the needed components, or task information to one or more approvers.

14. The method of claim 13, wherein the machine-readable medium stores instructions operable to cause one or more machines to perform further operations comprising: changing the designation one or more of the available needed components to unavailable.

15. The method of claim 13, wherein the machine-readable medium stores instructions operable to cause one or more machines to perform further operations comprising updating the database of components needed for various tasks to associate one or more unavailable needed components with the task when use of one or more of the unavailable needed components is approved by one or more of the approvers.

16. The method of claim 13, wherein the machine-readable medium stores instructions operable to cause one or more machines to perform further operations comprising automatically approving use of one or more of the unavailable needed components when one or more of the unavailable needed components satisfies predetermined criteria.

17. The method of claim 13, wherein transmitting the total price, identities of one or more of the needed components, and/or the bill of materials to one or more approvers comprises:
automatically transmitting the total price, identities of one or more of the needed components, and/or bill of materials to a first level of approvers; and
automatically transmitting the total price, identities of one or more of the needed components, the bill of materials, and/or the decision of the first level of approvers to one or more additional levels of approvers.

18. The method of claim 13, wherein the machine-readable medium stores instructions operable to cause one or more machines to perform further operations comprising updating a database of components in the inventory to add one or more unavailable needed components when use of one or more of the unavailable needed components is approved by at least one of the approvers.

19. A system comprising:
at least one database for storing data regarding a task, the data comprising:
a task information for various tasks, wherein a task comprises a change in a technology infrastructure for an enterprise;
identities of needed components for the various tasks; and
a listing of an inventory for the enterprise, wherein the listing comprises at least one of the following: identities of components, availabilities of components, or prices of components in the inventory;
a task management utility for managing the data stored in at least one of the databases.

20. The system of claim 19, the data further comprises one or more supply lists for one or more vendors comprising prices of one or more components available from the vendor.
